(19) United States
(12) Patent Application Publication
(10) Pub. No.: US 2024/0119568 A1
(43) Pub. Date: Apr. 11, 2024

(54) View Synthesis Pipeline for Rendering Passthrough Images

(71) Applicant: Meta Platforms Technologies, LLC, Menlo Park, CA (US)

(72) Inventors: Andrey Tovchigrechko, SARATOGA, CA (US); Fabian Langguth, Wädenswil (CH); Alexander Sorkine Hornung, Zurich (CH); Oskar Linde, San Carlos, CA (US); Christian Forster, Zofingen (CH)

(21) Appl. No.: 18/484,193

(22) Filed: Oct. 10, 2023

Related U.S. Application Data
(60) Provisional application No. 63/379,035, filed on Oct. 11, 2022.

(51) Int. Cl. G06T 5/00; G06T 7/10; G06T 7/285; G06T 17/20; G06T 19/20; G06V 20/20

(52) U.S. Cl. CPC G06T 5/002; G06T 5/005; G06T 7/10; G06T 7/285; G06T 17/20; G06T 19/20; G06V 20/20; G06T 2207/10012; G06T 2207/10028; G06T 2207/20021; G06T 2210/44; G06T 2219/2021

(57) ABSTRACT

A processor accesses a depth map and a first image of a scene generated using one or more sensors of an artificial reality device. The processor generates, based on the first image, segmentation masks respectively associated with a plurality of object types. The segmentation masks segment the depth map into a plurality of segmented depth maps respectively associated with the object types. The processor generates meshes using, respectively, the segmented depth maps. For each eye of the user, the processor captures a second image and generates, based on the second image, segmentation information. The processor warps the plurality of meshes to generate warped meshes for the eye, and then generates an eye-specific mesh for the eye by compositing the warped meshes according to the segmentation information. The processor renders an output image for the eye using the second image and the eye-specific mesh.

### PRIORITY

This application claims the benefit, under 35 U.S.C. § 119(e), of U.S. Provisional Patent Application No. 63/379,035, filed 11 Oct. 2022, which is incorporated herein by reference.

### TECHNICAL FIELD

This disclosure generally relates to computer graphics, and more specifically to mixed reality rendering techniques.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content, such as a mixed reality image, may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers.

“Passthrough” is a feature that allows a user to see their physical surroundings while wearing an artificial reality system. Information about the user's physical environment is visually “passed through” to the user by having the headset of the artificial reality system display information captured by the headset's external-facing cameras. The visual information, which may be referred to as “passthrough,” allows the user to see their physical surroundings while wearing an HMD. Information about the user's physical environment is visually “passed through” to the user by having the HMD display information captured by the headset's external-facing cameras. Simply displaying the captured images would not work as intended, however. Since the locations of the cameras do not coincide with the locations of the user's eyes, the images captured by the cameras do not accurately reflect the user's perspective. In addition, since the images have no depth, simply displaying the images would not provide the user with proper parallax effects if he were to shift away from where the images were taken. Incorrect parallax, coupled with user motion, could lead to motion sickness. Accordingly, depth information is an important component for the passthrough rendering process.

### SUMMARY OF PARTICULAR EMBODIMENTS

Particular embodiments described herein relate to an improved view synthesis pipeline or architecture for rendering depth-accurate passthrough images for the left and right eyes of the user. In the MR context, a sequence of frames of passthrough images is rendered to provide an immersive experience. Since each passthrough image is generated based on a corresponding depth map, the temporal consistency of the depth maps plays an important role in ensuring a consistent, smooth passthrough experience.

Particular embodiments provide techniques for improving the temporal consistency and smoothness of depth maps used for rendering passthrough images. An original depth map output by one or more sensors for the current frame may be temporally smoothed using optical flow data generated from images of the scene. The original depth map, which may be associated with time t, may be noisy and lacks temporal consistency with a previous depth map associated with time t−1. Temporally smoothing the original depth map before using it to generate passthrough images may be desirable. It is preferable to temporally smooth the original depth map using optical flow data generated from a source different from the depth map, because such optical flow data provides independent information for correcting the depth map. In one example, optical flow data may be generated using images of the scene. The image may be a brightness image (e.g., a monochrome image encoding the luminance of the scene), which may be generated as a by-product when a depth map is generated. For example, a brightness image may be generated by a time-of-flight sensor, or it may be one of the images of a stereo pair of images used to compute depth. In particular embodiments, a computing system may generate optical flow data to represent motion between a previous brightness image (e.g., associated with time t−1) and the current brightness image (e.g., associated with time t). Optical flow may be computed using conventional techniques, including finding pixel correspondences between pixels in the two images and encoding the correspondence using motion vectors. The optical flow data may then be used to temporally smooth the original depth map. For example, a computing system may apply the optical flow data to a previous depth map (e.g. associated with time t−1) to generate a predicted depth map that is associated with the same time instance as the original depth map (e.g., associated with time t). The predicted depth map may then be used to improve the temporal smoothness and reduce noise in the original depth map. For example, the predicted depth map and the original depth map may be averaged to generate a depth map (e.g., updated/adjusted depth map) to be used by the rest of the pipeline to generate passthrough images for the current frame.

As previously mentioned, passthrough images are generated by reprojecting passthrough images captured by cameras of an artificial-reality device toward the user's eye positions using depth measurements of the scene. Since the left and right passthrough images are captured from two different viewpoints, it would be preferable to obtain depth measurements for those viewpoints using two depth sensors, one for each eye. However, due to system constraints and costs, it may not be feasible to have two depth sensors on a head-mounted device that is power-constrained. Having a single depth sensor to measure depth is more practical, and the measured results could be warped to the viewpoints of the passthrough cameras.

In one embodiment, depth measurements from a depth sensor may generate a single mesh to represent the entire scene. Doing so may have computational benefits, but since the depth mesh would need to be warped to the viewpoints of the two passthrough cameras, inaccuracies and blurred boundaries could result, especially between background and foreground objects. Therefore, in particular embodiments, it is preferable to use multiple depth maps and corresponding depth meshes to represent different types of objects in the scene. One advantage of using multiple depth maps, as compared to using a single depth map, is that they can more accurately represent depths in the scene and retain sharper boundaries between meshes, especially after warping. In addition, particular embodiments may group depth measurements by object type so that each of the depth maps may be associated with a particular predetermined object type. The additional knowledge of the object type associated with each group of depth measurements further allows the depth measurements to be refined using known geometric constraints or other characteristics of the known object types. Examples of the object types include, but are not limited to static background scene, planes, the user's body, other people in the scene, pets, other dynamic objects, etc. Yet another benefit of having K depth maps and meshes is that each one may be separately interpolated and extrapolated in areas where direct depth measurement was not performed. The missing information may be filled using any suitable method, such as Laplacian solver/filter, so that the entire field of view of the user has depth information. The end result is that the K meshes would have no holes (i.e., each mesh covers the entire field of view of the user).

In particular embodiments, the processing pipeline may first use an ML-based semantic segmentation model to process an image of the scene (e.g., the brightness image) to generate K segmentation masks, each identifying pixels in the image corresponding to a particular type of object. The K segmentation masks may then segment the depth map into K separate portions. For example, for a given segmentation mask associated with the user's body (e.g., visible portions of the user's arms), the pixels in the mask identify which pixels in the brightness image correspond to the user's body. Those identified pixels may in turn identify pixels in the depth map (e.g., the depth map that has been temporally smoothed using techniques described above) that correspond to the user's body. The identified pixels in the depth map may then be extracted to form a segmented depth map that contains only depth measurements corresponding to the user's body. By applying K segmentation masks to the depth map, a corresponding K segmented depth maps may be generated.

A segmented depth map may have missing depth information, which may be due to the sparsity of depth measurements and the fact that a segmented depth map contains only a portion of the information in the source depth map. For example, the segmented depth map for the background may have missing depth information corresponding to where foreground objects exists in the source depth map. In particular embodiments, missing depth information in each segmented depth map may be filled before the segmented depth map is used to generate a mesh. The missing information may be filled using any suitable method, such as the Laplacian solver or other filters, so that the final segmented depth map is filled and has no missing information. The filled segmented depth maps may then be converted into a corresponding mesh.

In particular embodiments, each segmented depth map or its corresponding mesh, which is associated with a particular object type, may be refined using information known about that object type. For example, planes should be planar, the user's body should relate to physical human anatomical constraints, background scenes or static objects should be temporally stable, etc. In particular embodiments, known models of each object type may be used to generate meshes that best fit the observed depth measurements. For example, one or more service components/modules may be configured to track and generate models for particular types of objects that are present in the scene. For instance, one service component may be configured to detect and generate 3D meshes for the user's hands; another service component may be configured to detect and generate 3D meshes for people; and yet another service component may be configured to generate 3D meshes for static objects and/or planes in the scene. These components may generate 3D meshes for a particular type of object by fitting a 3D model with particular geometric constraints to the observed depth measurements. For example, a hand service component for generating meshes for hands may first detect a hand in a scene and identify its keypoints (e.g., joints or other predetermined features). The keypoints may then be used to configure the pose of a 3D model of a hand. An optimization algorithm may adjust the parameters of the 3D model so that it would best fit the observed depth information while still staying within the geometric or other constraints associated with a hand (e.g., the amount in which a finger could bend is physically limited). Once the hand service component generates a final hand model, the view synthesis pipeline may use it to refine its hand meshes or corresponding segmented depth maps for hands. For example, the view synthesis pipeline may improve the mesh it generated from a segmented depth map of the user's hands by replacing any corresponding portions of the mesh with the 3D model output by the hand service component. In other embodiments, the view synthesis pipeline may refine the segmented depth map by comparing it to the 3D model output by the hand service component. For example, depth measurements in the segmented depth map that fall outside of the 3D model may be treated as noise and filtered out from the segmented depth map. The K filtered segmented depth map, in turn, may be converted into K meshes.

The K meshes represent objects within the scene observed from the viewpoint of the depth sensor (e.g., time-of-flight sensor, stereo depth sensor, etc.) at a first time instance. In particular embodiments, before using the K meshes for rendering the output passthrough images, they are warped to represent objects within the scene observed from the viewpoint of the passthrough cameras at a second time instance. For context, an artificial reality device may have additional passthrough cameras for capturing images that will be used to generate passthrough images. These additional passthrough cameras may be color cameras and may be different from the depth sensor. For example, an artificial reality device may have a left passthrough camera for capturing images that will be “passed through” to a display for the user's left eye, and a right passthrough camera for capturing images that will be similarly “passed through” to a display for the user's right eye. Since these passthrough cameras are not co-located with the depth sensor, the depth of the scene as seen by these cameras would be different from the depth measured by the depth sensor. To account for the viewpoint differences, the computing system may warp the K meshes so that they represent the scene depth as seen from the perspectives of the passthrough cameras. 3D warping may also account for changes in the pose of the artificial reality device. The depth sensor measurements, which is the underlying data used to generate the K meshes, may have been captured at a different time than the images captured by the passthrough cameras. During this time difference, the user and/or objects in the scene could have moved. The 3D warping process may account for this movement by warping the K meshes based on changes in the pose of the artificial reality device, which is tracked using conventional tracking methods (e.g., SLAM), along with extrinsic and intrinsic parameters of the passthrough cameras. In particular embodiments, the resulting K warped meshes for the left eye represent the K meshes as observed from the perspective of the left passthrough camera at the moment in time when it captured the left passthrough image. Similarly, another set of K warped meshes for the right eye represent the K meshes as observed from the perspective of the right passthrough camera at the moment in time when it captured the right passthrough image.

Once the K warped meshes have been generated for each eye, the passthrough view synthesis pipeline may then use the warped meshes to composite a final depth mesh corresponding to the passthrough image. For the left eye, the passthrough view synthesis pipeline may use any conventional machine-learning segmentation technique to process the passthrough image captured by the left eye's passthrough camera to generate segmentation information identifying pixels in the passthrough image that correspond to the aforementioned plurality of object types. The pipeline may then generate an eye-specific mesh for the left eye by compositing the plurality of warped meshes for the left eye according to the segmentation information of the passthrough image for the left eye. For example, pixels in the left-eye's passthrough image that are associated with the user's body would correspond to a portion of the left-eye's warped mesh associated with the user's body. Similarly, pixels in the left-eye's passthrough image that are associated with the background would correspond to a portion of the left-eye's warped mesh associated with the background. Those portions of the warped meshes corresponding to the segmentation pixels may be combined to form a complete eye-specific mesh for the left eye. The eye-specific mesh represents depth information that would be observed from the viewpoint of the left-eye's camera. In other embodiments, the eye-specific depth information may be represented using a depth map instead of a mesh. The process described above for generating a complete eye-specific mesh for the left eye is similar to the process for generating a complete eye-specific mesh for the right eye, except that the passthrough image used would be captured by a passthrough camera for the right eye, and the warped meshes used would be those created for the right eye. Once the eye-specific meshes for the left and right eyes have been created, they would be used to reproject, respectively, the left and right passthrough images to generate the final output passthrough images for the left and right eyes.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Particular embodiments use a computing system to access a depth map and a first image of a scene generated using one or more sensors of an artificial reality device; generate, based on the first image, a plurality of segmentation masks respectively associated with a plurality of object types, wherein each segmentation mask identifies pixels in the first image that correspond to the object type associated with that segmentation mask; segment, using the plurality of segmentation masks, the depth map into a plurality of segmented depth maps respectively associated with the plurality of object types; and generate a plurality of meshes using, respectively, the plurality of segmented depth maps. Then, for each eye of a user, the computing system captures a second image of the scene; generates, based on the second image, segmentation information identifying pixels in the second image that correspond to the plurality of object types; warps the plurality of meshes to generate a plurality of warped meshes for the eye; generates an eye-specific mesh for the eye by compositing the plurality of warped meshes for the eye according to the segmentation information of the second image; and renders an output image for the eye using the second image and the eye-specific mesh.

In particular embodiments, the depth map is generated by temporally smoothing an original depth map output by the one or more sensors. In particular embodiments, temporally smoothing the original depth map to generate the depth map comprises: generating optical flow data to represent motion between the first image and a previous image captured by the one or more sensors; generating a predicted depth map associated with a same time stance as the original depth map by applying the optical flow data to a previous depth map; and generating the depth map based on the original depth map and the predicted depth map. In particular embodiments, the depth map is generated by averaging the original depth map and the predicted depth map.

In particular embodiments, the one or more sensors comprise a time-of-flight sensor, and the first image is an output of the time-of-flight sensor.

In particular embodiments, the one or more sensors comprise a pair of stereo cameras, and the first image is output by one camera of the pair of stereo cameras.

In particular embodiments, before generating the plurality of meshes, the computing system fills missing depth information in at least one of the segmented depth maps using a filter, wherein the plurality of meshes are generated using the plurality of depth maps after the missing information is filled.

In particular embodiments, generating the plurality of meshes further comprises using one or more 3D models of the plurality of object types.

In particular embodiments, at least one mesh of the plurality of meshes is generated by: identify an object type associated with the mesh, the object type being selected from the plurality of object types; generating one or more 3D models of the identified object type that fit observed features of one or more objects of the identified object type present in the scene; and using the one or more 3D models to refine the mesh generated from the associated segmented depth map. In particular embodiments, the identified object type is at least one of planes, people, or static objects in the scene observed over a period of time.

In particular embodiments, the plurality of warped meshes, the eye-specific mesh, and the output image generated for a left eye of the user are different from the plurality of warped meshes, the eye-specific mesh, and the output image generated for a right eye of the user.

In particular embodiments, the plurality of warped meshes for the eye is generated by warping the plurality of meshes based on a location of a camera of the artificial reality device used for capturing the second image. In particular embodiments, the plurality of warped meshes for the eye is generated by warping the plurality of meshes based on an updated pose of the artificial reality device.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example artificial reality system worn by a user, in accordance with particular embodiments.

FIG. 2 illustrates an example of a passthrough feature, in accordance with particular embodiments.

FIG. 3 illustrates the difference between images of the same scene captured by two different cameras.

FIG. 4 provides an illustration of 3D-passthrough rendering based on a 3D model of the environment.

FIG. 5 illustrates an example problem when rendering a passthrough image based on inaccurate depth measurements.

FIG. 6 illustrates another example problem when rendering a passthrough image based on inaccurate depth measurements.

FIG. 7 illustrates an example block diagram of an improved view synthesis architecture or pipeline for rendering depth-accurate passthrough images.

FIG. 8 illustrates an example source image of a visual scene including various objects and an example depth mesh that may be created for one or more specific objects of the visual scene.

FIG. 9 illustrates an example method for rendering a depth-accurate passthrough image using the improved view synthesis pipeline discussed herein, in accordance with particular embodiments.

FIG. 10 illustrates an example network environment associated with an artificial reality system.

FIG. 11 illustrates an example computer system.

### DESCRIPTION OF EXAMPLE EMBODIMENTS

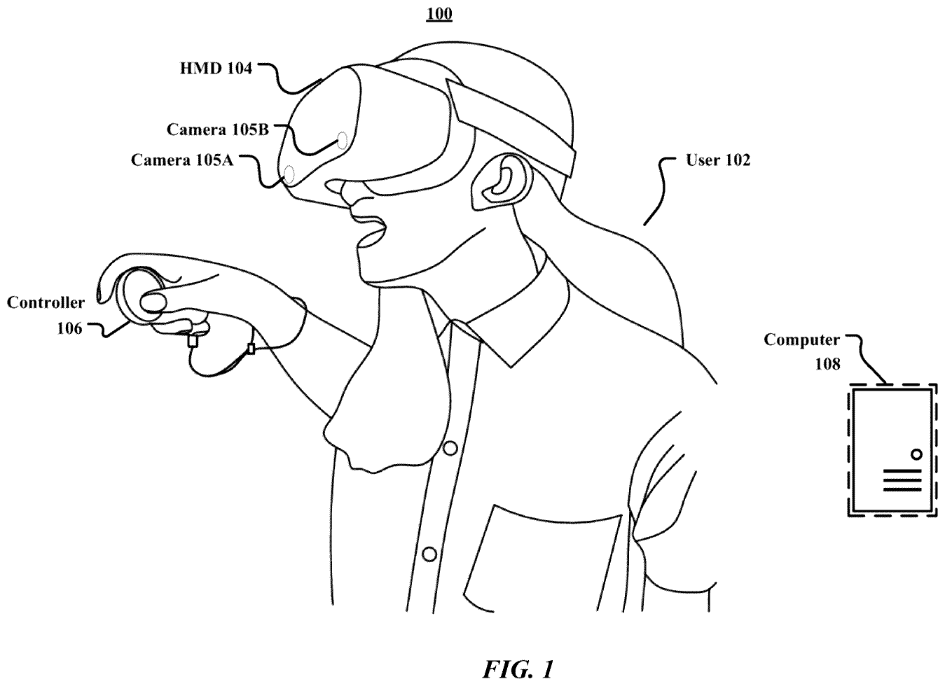

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content, such as a mixed reality image, may include completely generated content or generated content combined with captured content (e.g., real-world photographs). Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers. One example artificial reality system is shown in at least FIG. 1, which is discussed below.

“Passthrough” is a feature that allows a user to see their physical surroundings while wearing an artificial reality system, such as the artificial reality system 100 shown in FIG. 1. Information about the user's physical environment is visually “passed through” to the user by having the headset of the artificial reality system display information captured by the headset's external-facing cameras. The visual information, which may be referred to as “passthrough,” allows the user to see their physical surroundings while wearing an HMD. Information about the user's physical environment is visually “passed through” to the user by having the HMD display information captured by the headset's external-facing cameras. Simply displaying the captured images would not work as intended, however. Since the locations of the cameras do not coincide with the locations of the user's eyes, the images captured by the cameras do not accurately reflect the user's perspective. In addition, since the images have no depth, simply displaying the images would not provide the user with proper parallax effects if he were to shift away from where the images were taken. Incorrect parallax, coupled with user motion, could lead to motion sickness. Thus, to generate correct parallax and rather than simply displaying the captured images, accurate depth information of a visual scene is also needed and be combined with captured images in order to reconstruct depth-accurate passthrough images representing the visual scene from the user's current viewpoint.

FIG. 1 illustrates an example of an artificial reality system 100 worn by a user 102. In particular embodiments, the artificial reality system 100 may comprise a head-mounted device (“HMD”) 104, a controller 106, and a computing system 108. The HMD 104 may be worn over the user's eyes and provide visual content to the user 102 through internal displays (not shown). The HMD 104 may have two separate internal displays, one for each eye of the user 102. As illustrated in FIG. 1, the HMD 104 may completely cover the user's field of view. By being the exclusive provider of visual information to the user 102, the HMD 104 achieves the goal of providing an immersive artificial-reality experience. One consequence of this, however, is that the user 102 would not be able to see the physical environment surrounding him, as his vision is shielded by the HMD 104. As such, the passthrough feature described herein is needed to provide the user with real-time visual information about their physical surroundings.

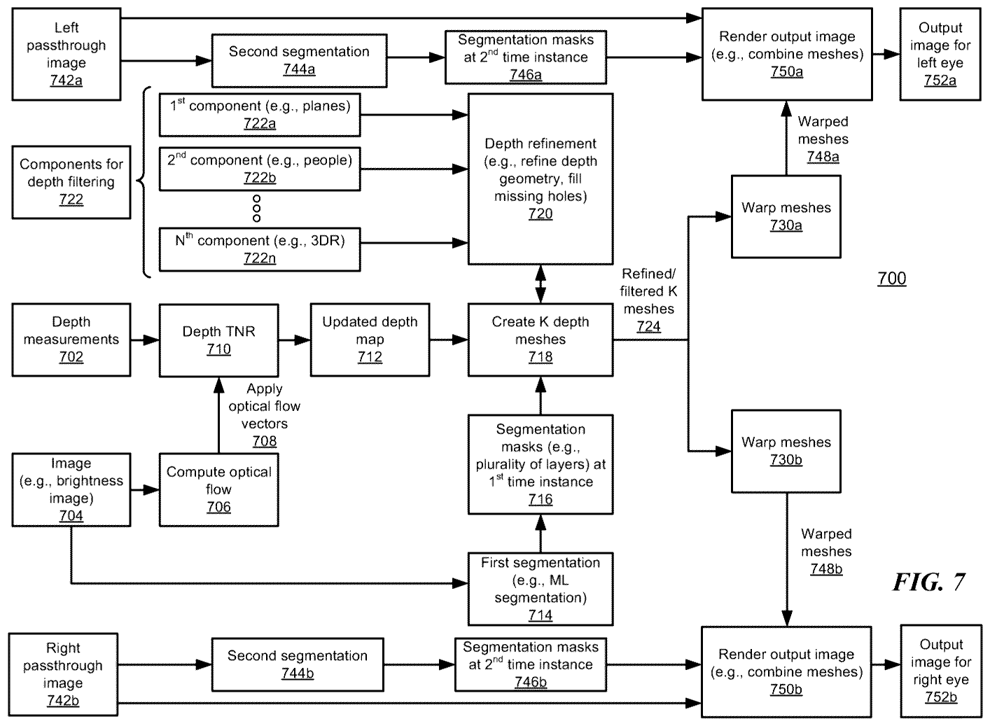

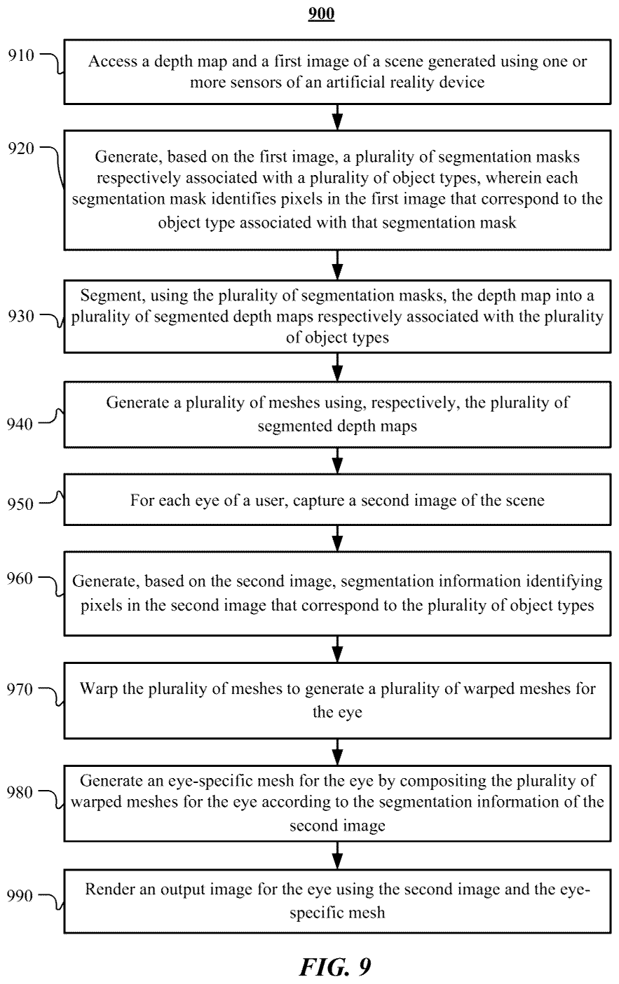

The HMD 104 may have external-facing cameras, such as the two forward-facing cameras 105A and 105B shown in FIG. 1. In particular embodiments, camera 105A may be used to capture images that will be “passed through” to the user's right eye, and camera 105B may be used to capture images that will be “passed through” to the user's left eye. While only two forward-facing cameras 105A-B are shown, the HMD 104 may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras are configured to capture the physical environment around the user and may do so continuously to generate a sequence of frames (e.g., as a video). As previously explained, although images captured by the forward-facing cameras 105A-B may be directly displayed to the user 102 via the HMD 104, doing so would not provide the user with an accurate view of the physical environment since the cameras 105A-B cannot physically be located at the same location as the user's eyes. In addition, since the images have no depth, simply displaying the images would not provide the user with proper parallax effects if he were to shift away from where the images were taken. Incorrect parallax, coupled with user motion, could lead to motion sickness. As such, accurate depth information of a visual scene or user's physical environment is also needed when rendering passthrough images. The present disclosure describes an improved view synthesis pipeline for rendering depth-accurate passthrough images. The improved view synthesis pipeline is discussed later in detail in reference to at least FIG. 7 and FIG. 9.

Three-dimensional (3D) representation may be generated based on depth measurements of physical objects observed by a depth sensor. Depth may be measured in a variety of ways. In particular embodiments, depth may be measured using a depth sensor (not shown), which may be a time-of-flight (ToF) sensor. The ToF sensor may determine the depths within its field of view by measuring the amount of time it takes for a photon to reflect back from objects in the scene. The ToF sensor may output a depth map that specifies the depth measurements within the scene and a brightness image that specifies the brightness in the scene. In particular embodiments, depth may alternatively be computed based on stereo images. For example, the two forward-facing stereo cameras may share an overlapping field of view and be configured to capture images simultaneously. As a result, the same physical object may be captured by both cameras at the same time. For example, a particular feature of an object may appear at one pixel p_{A} in the image captured by one camera, and the same feature may appear at another pixel p_{B} in the image captured by the other camera. As long as the depth measurement system knows that the two pixels correspond to the same feature, it could use triangulation techniques to compute the depth of the observed feature. For example, based on the camera's position within a 3D space and the pixel location of p_{A} relative to the camera's field of view, a line could be projected from the camera and through the pixel p_{A}. A similar line could be projected from the other camera and through the pixel p_{B}. Since both pixels are supposed to correspond to the same physical feature, the two lines should intersect. The two intersecting lines and an imaginary line drawn between the two cameras form a triangle, which could be used to compute the distance of the observed feature from either camera or a point in space where the observed feature is located. The resulting depth information may be stored using a depth map, which may be represented using a matrix of pixels, where each pixel encodes the depth of an object observed through that pixel.

In particular embodiments, the pose (e.g., position and orientation) of the HMD 104 within the environment may be needed. For example, in order to render the appropriate display for the user 102 while he is moving about in a virtual environment, the system 100 would need to determine his position and orientation at any moment. Based on the pose of the HMD, the system 100 may further determine the viewpoint of either of the cameras 105A and 105B or either of the user's eyes. In particular embodiments, the HMD 104 may be equipped with inertial-measurement units (“IMU”). The data generated by the IMU, along with the stereo imagery captured by the external-facing cameras 105A-B, allow the system 100 to compute the pose of the HMD 104 using, for example, SLAM (simultaneous localization and mapping) or other suitable techniques.

In particular embodiments, the artificial reality system 100 may further have one or more controllers 106 that enable the user 102 to provide inputs. The controller 106 may communicate with the HMD 104 or a separate computing unit 108 via a wireless or wired connection. The controller 106 may have any number of buttons or other mechanical input mechanisms. In addition, the controller 106 may have an IMU so that the position of the controller 106 may be tracked. The controller 106 may further be tracked based on predetermined patterns on the controller. For example, the controller 106 may have several infrared LEDs or other known observable features that collectively form a predetermined pattern. Using a sensor or camera, the system 100 may be able to capture an image of the predetermined pattern on the controller. Based on the observed orientation of those patterns, the system may compute the controller's position and orientation relative to the sensor or camera.

The artificial reality system 100 may further include a computer unit 108. The computer unit may be a stand-alone unit that is physically separate from the HMD 104 or it may be integrated with the HMD 104. In embodiments where the computer 108 is a separate unit, it may be communicatively coupled to the HMD 104 via a wireless or wired link. The computer 108 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 100 depends on the capabilities of its computer unit 108.

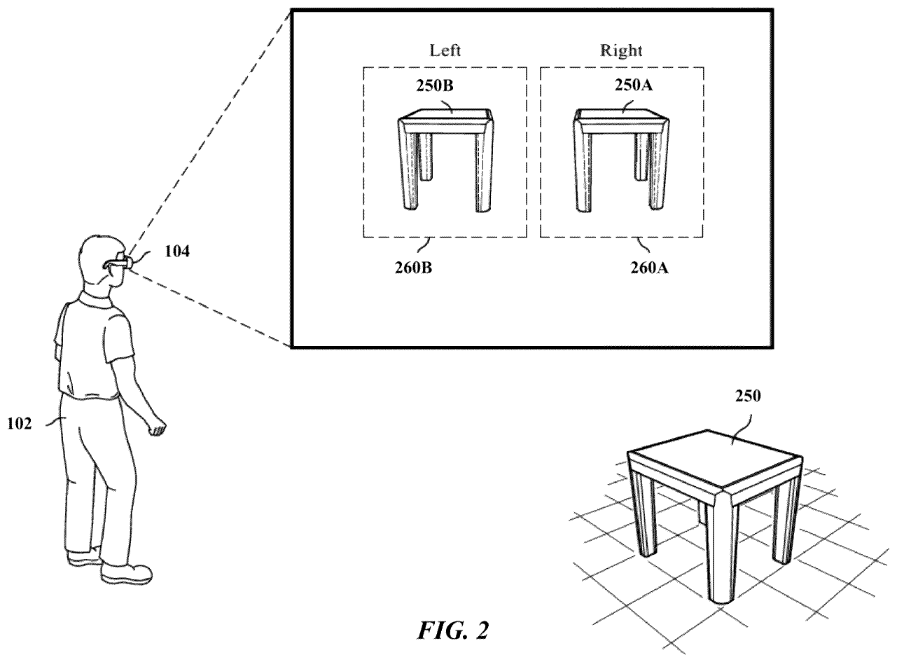

FIG. 2 illustrates an example of the passthrough feature. A user 102 may be wearing an HMD 104, immersed within a virtual reality environment. A physical table 250 is in the physical environment surrounding the user 202. However, due to the HMD 104 blocking the vision of the user 102, the user is unable to directly see the table 250. To help the user 102 perceive his physical surroundings while wearing the HMD 104, the passthrough feature captures information about the physical environment using, for example, external-facing cameras 105A-B of the HMD 104. The captured information may then be re-projected to the user 102 based on his viewpoints. In particular embodiments where the HMD 104 has a right display 260A for the user's right eye and a left display 260B for the user's left eye, the computing system 108 may individually render (1) a re-projected view 250A of the physical environment for the right display 260A based on a viewpoint of the user's right eye and (2) a re-projected view 250B of the physical environment for the left display 260B based on a viewpoint of the user's left eye.

Reprojection is performed using depth information of the scene. At a high-level, depth information encoded using a depth map or depth mesh may be treated like the 3D geometry of the scene. The images are treated like textures for the 3D geometry. Conceptually, an image captured by a camera having one viewpoint may be reprojected to another viewpoint by rendering the scene using the 3D geometry and corresponding texture.

A variety of methods may be used to capture depth information of the scene. For example, in the case of stereo depth sensors that capture stereo images, a high-performance computing unit may solve the correspondence problem using a GPU and optical flow techniques, which are optimized for determining correspondences. The correspondence information between the stereo images may then be used to compute depths using triangulation techniques. Based on the computed depths of the observed features, the computing unit could determine where those features are located within a 3D space (since the computing unit also knows where the cameras are in that 3D space). The result may be represented by a dense 3D point cloud, with each point corresponding to an observed feature. The dense point cloud may then be used to generate 3D models (e.g., a 3D depth mesh or depth map) of objects in the environment. When the system renders a scene for display, the system could perform visibility tests from the perspectives of the user's eyes. For example, the system may cast rays into the 3D space from a viewpoint that corresponds to each eye of the user. In this manner, the rendered scene that is displayed to the user would be computed from the perspective of the user's eyes, rather than from the perspective of the external-facing cameras.

Once the computing device has generated a point cloud based on the depth measurements, which may be encoded as a depth map, the depth information may be used to generate a 3D mesh representation of the observed environment. For high-performance devices, accurate models of objects in the environment may be generated (e.g., each object, such as a table or a chair, may have its own 3D model). However, for resource-limited devices, the cost of generating such models and/or the underlying depth measurements for generating the models may be prohibitive. Thus, in particular embodiments, the 3D mesh representation for the environment may be a coarse approximation of the general contour of the objects in the environment. In particular embodiments, a single 3D mesh may be used to approximate all the objects observed. Conceptually, the 3D mesh is analogous to a blanket or sheet that covers the entire observable surfaces in the environment. In particular embodiments, the mesh may be initialized to be equal-distance (e.g., 1, 2, 2.5, or 3 meters) from a viewer or camera. Since the 3D mesh is equal-distance away from the viewer, it forms a hemisphere around the user. The 3D mesh may be deformed according to the depth measurements of the observed physical objects in order to model the contour of the environment. In particular embodiments, the 3D mesh may be deformed based on the viewer's position and a point-cloud representation of the depth measurements. To determine which portion of the 3D mesh corresponds to each point in the point cloud, the computing device may cast a conceptual ray from the viewer's position towards that point. Each ray would intersect with a primitive (e.g., a triangle or other polygon) of the 3D mesh. As a result, the point of intersection on the mesh is deformed based on the depth value associated with the point through which the ray was cast. For example, if the depth measurement of the point is 2.2 meters away from the viewer, the initial 2-meter depth value associated with the point of intersection on the mesh may be changed to 2.2 meters. Once this process has been completed for each point in the point cloud, the resulting deformed mesh would represent the contour of the physical environment observed by the viewer.

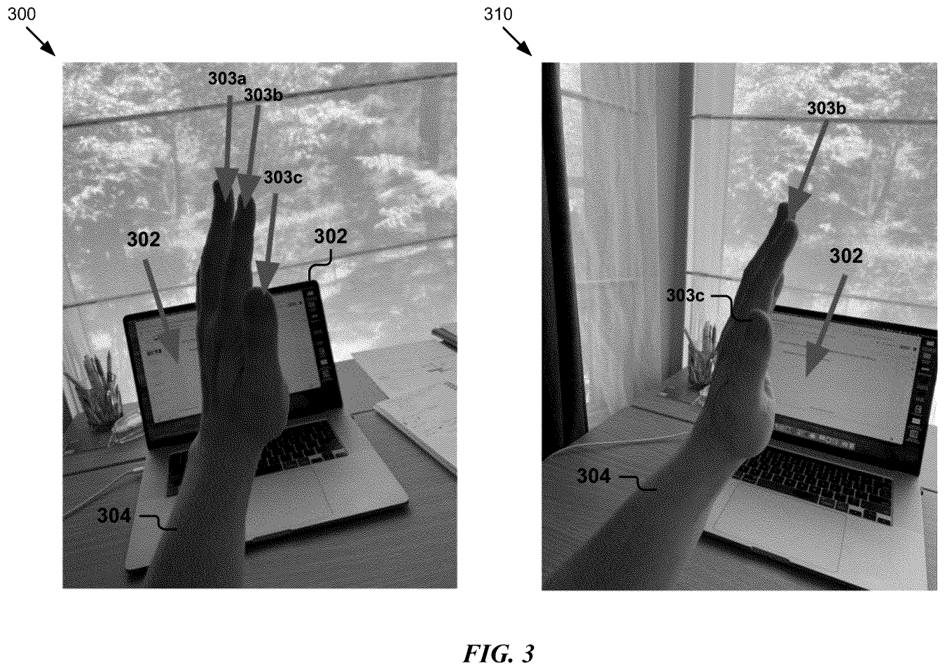

Representing the entire scene using a single mesh may be computationally efficient, but the single-mesh representation sacrifices depth accuracy, especially at the boundaries between foreground and background objects that are far apart. FIG. 3 illustrates the difference between images 300 and 310 of the same scene captured by two different cameras. As shown, even though the same scene is captured by the left and right passthrough cameras, the images 300 and 310 are significantly different due to the difference in the viewpoints of the cameras. The differences are even more pronounced when foreground objects occlude background objects. As seen, in the left image 300, the center of the laptop 302 is occluded by the user's hand 304, whereas in the right image 310, only the left portion of the laptop 302 is occluded by the hand 304. Also, in the left image 300, three fingers 303a, 303b, 303c of the user's hand 304 are clearly visible, whereas only the thumb 303c and index finger 303b are clearly visible in the right image 310. This example demonstrates that the difference between what is observed by the left and right passthrough cameras could be significant. As such, the meshes used for reprojecting the images captured by the two cameras should be generated for their respective perspectives. This is the rationale for generating a set of K meshes for the left eye and another set of K meshes for the right eye.

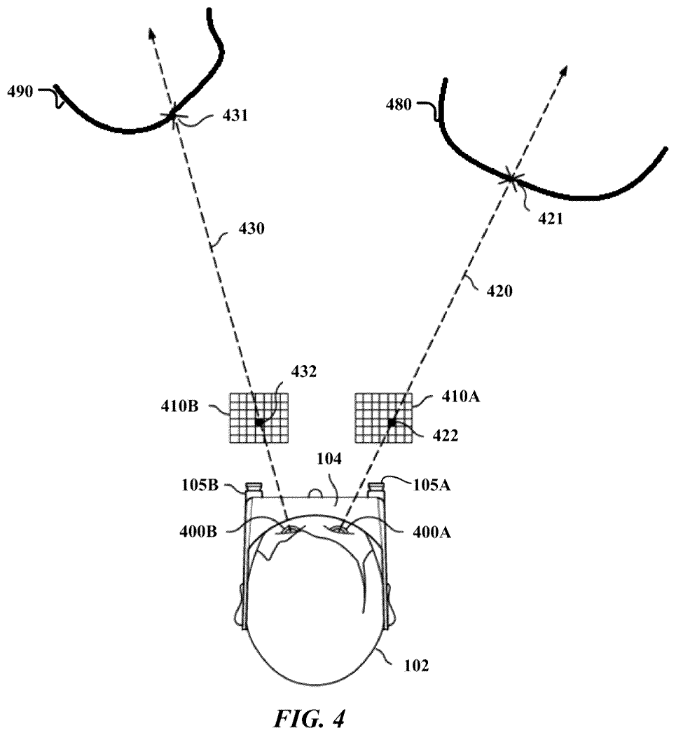

FIG. 4 provides an illustration of 3D-passthrough rendering based on a 3D model of the environment. In particular embodiments, the rendering system may determine the user's 102 current viewing position relative to the environment. In particular embodiments, the system may compute the pose of the HMD 104 using SLAM or other suitable techniques. Based on the known mechanical structure of the HMD 104, the system could then estimate the viewpoints of the user's eyes 400A and 400B using offsets from the pose of the HMD 104. The system may then render a passthrough image for each of the user's eyes 400A-B. For example, to render a passthrough image for the user's right eye 400A, the system may cast a ray 420 from the estimated viewpoint of the right eye 400A through each pixel of a virtual screen space 410A to see which portion of a 3D model would be intersected by the ray 420. This ray casting process may be referred to as a visibility test, as the objective is to determine what is visible from the selected viewpoint 400A. In the particular example shown, the ray 420 projected through a particular pixel 422 intersects with a particular point 421 on the 3D model 480. This indicates that the point of intersection 421 is to be displayed by the pixel 422. Once the point of intersection 421 is found, the rendering system may sample a corresponding point in a texture image that is mapped to the point of intersection 421. In particular embodiments, the image captured by the cameras 105A-B of the HMD 104 may be used to generate a texture for the 3D model 480. Doing so allows the rendered image to appear more like the actual physical object. In a similar manner, the rendering system may render a passthrough image for the user's left eye 400B. In the example shown, a ray 430 may be cast from the left-eye viewpoint 400B through pixel 432 of the left screen space 410B. The ray 430 intersects the 3D model 490 at location 431. The rendering system may then sample a texture image at a texture location corresponding to the location 431 on the model 490 and compute the appropriate color to be displayed by pixel 432. Since the passthrough images are re-rendered from the user's viewpoints 400A-B, the images would appear natural and provide proper parallax effect.

As discussed earlier, depth information is an important component for the passthrough rendering process. Depth information may be measured based on correspondence between stereo images. Alternatively, depth information may be obtained through dedicated depth sensor(s), such as time-of-flight sensors, that may be integrated within an artificial reality system, such as artificial reality system 100. However, the depth sensors have measurement errors, low resolution, and do not work on some object types. Also, computing depth based on stereo images is prone to errors and mistakes. Due to this, measuring scene geometry for artificial reality, such as mixed reality, is generally difficult and not very accurate. This is a key problem for artificial reality devices (e.g., mixed reality devices), overcoming which defines to a large extent the commercial success of an AR/VR device.

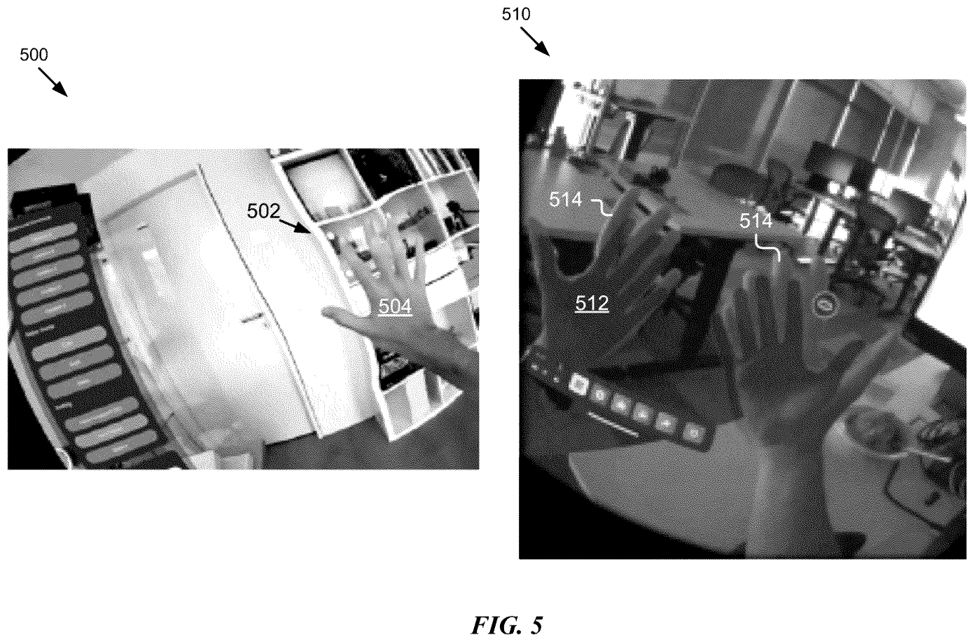

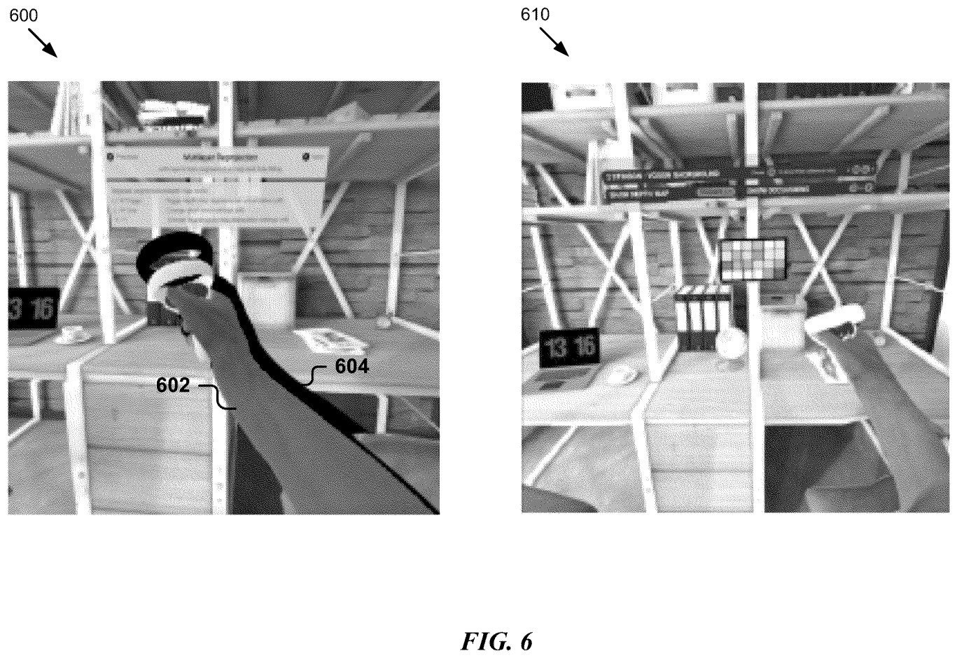

As previously mentioned, one method for representing depth information within a scene is by using a single blanket mesh. While using a single mesh may have computational benefits, it is a rough approximation of the depth in the scene and contains inaccuracies, especially at the boundaries between foreground and background objects. FIGS. 5 and 6 illustrate example problems arising when rendering passthrough images based on such inaccurate depth measurements. In particular, FIG. 5 illustrates an example problem of using a single mesh to represent depths within a scene. For example, left image 500 shows that the background 502 around the user's hand 504 is deformed. This rendering artifact is due to the inaccurate depth representation between a portion of the mesh corresponding to the hand 504 and the portion corresponding to the background 502. These two portions of the mesh are connected in a single-mesh depth representation. Right image 510 shows a mismatch between the passthrough image 512 of the user's hand and the location 514 of the user's hand as determined by a hand-tracking algorithm. The mismatch observed is also attributable to inaccuracies in the mesh.

FIG. 6 illustrates another example problem when rendering a passthrough image based on inaccurate depth measurement. Close objects present a challenge because they are moving faster and inaccuracies in depth measurement would result in an inaccurate mesh representation for the entire scene. For example, the left image 600 in FIG. 6 shows a gap between the user's arm 602 and the background 604. This is an undesirable artifact that occurred because the blanket mesh that represents the scene has inaccuracies around the edges of the user's arm 602. One solution is to fill the gap area with a neural color, as shown in the right image 610. Tests have shown that good results are obtained if these transition areas are filled with distorted textures. This simplifies rendering and avoids sudden changes in brightness that can be too intrusive to the eyes.

Accordingly, there is need to generate accurate and/or reliable depth measurements when rendering passthrough images for a user immersed in artificial reality via their artificial reality system. FIG. 7 illustrates an example block diagram 700 of an improved view synthesis architecture/pipeline for rendering depth-accurate passthrough images. It should be noted that operations associated with various blocks 702-752 of the improved view synthesis pipeline may be performed by the computer unit 108 of the artificial reality system 100 or the computer system 1100. Although this disclosure describes and illustrates particular blocks of the improved view synthesis pipeline of FIG. 7 as occurring in a particular order, this disclosure contemplates any suitable blocks of the improved view synthesis pipeline of FIG. 7 occurring in any suitable order.

In particular embodiments, view synthesis is a part of the mixed reality (MR) pipeline. The old pipeline needs to be updated to address passthrough rendering issues, such as, for example, close object and rendering issues, as discussed, for example, in FIGS. 5 and 6. The improved pipeline may especially be needed with respect to rendering certain objects (e.g., hands), which have been identified as critical to provide an accurate MR experience.

As depicted, raw depth measurements 702 and an image 704 may be obtained as input to the pipeline. For instance, one or more sensors associated with an artificial reality system 100 may produce the depth measurements 702 as well the image 704. The one or more sensors may be depth sensors, such as time-of-flight sensors, which may be capable of producing depth measurements and brightness images. For instance, for each pixel, a depth sensor may produce a depth value and an amplitude signal indicative of a measure of brightness of the pixel. In some embodiments, the depth measurements 702 and the image 704 (e.g., brightness image) may be produced by a time-of-flight (ToF) sensor. For instance, the ToF sensor may send a signal out and then determine how long it takes to receive the reflection back from an object. Based on this, the ToF sensor may produce depth measurements 702 and a corresponding brightness image 704, both of which being associated with a current time. In some other embodiments, stereo images may be obtained through stereo cameras (e.g., cameras 105A-105B) of the artificial reality system 100 and then the depth measurements 702 are obtained by comparing the stereo images and using triangulation techniques to compute depth. In such a scenario where stereo cameras are used, one of the stereo images associated with one eye (e.g., left eye or right eye) may simply be used as a brightness image 704.

The raw depth measurements 702 may be represented as a depth map, which may be implemented as a two-dimensional matrix of pixels, where each pixel holds a depth measurement. As discussed elsewhere herein, depth measurements 702 may contain noise and may be inaccurate, and the depth measurements 702 from frame to frame may be independently captured and lack temporal consistency. Stated differently, two consecutive depth maps (e.g., depth maps respectively corresponding to image frame N−1 and frame N) may not be temporally consistent with respect to each other and/or may be temporally unstable. Rendering passthrough images based on such temporally unstable depth maps may lead to a lack of temporal smoothness between frames.

In particular embodiments, to temporally align the depth maps, first optical flow is computed (e.g., as indicated by block 706) using a sequence of images, including the image 704. Optical flow is a technique used to represent motion (e.g., object motion) between a sequence or series of images. In particular embodiments, computing the optical flow may include determining a correspondence between a first image (e.g., image frame N−1) and a second image (e.g., image frame N) of the sequence of images and calculating motion vectors based on this correspondence. The motion vectors may be the optical flow vectors discussed herein. Once the optical flow is computed and optical flow vectors (or motion vectors) are obtained, depth temporal noise reduction (depth TNR) 710 is performed using the optical flow to improve the temporal consistency of the depth map obtained based on the depth measurements 702. In particular embodiments, the optical flow data, which specifies pixel-level motion of objects in the scene from frame N−1 to N, may be applied to a previous depth map associated with frame N−1 to generate a predicted depth map for frame N. The predicted depth map for frame N may then be used to update and denoise the currently captured depth map obtained based on depth measurements 702 for frame N. In one example, the predicted depth map and the current depth map (e.g., depth map based on depth measurements 702) may be combined (e.g., averaged) to generate an updated or adjusted depth map 712 to be used by the rest of the pipeline. The depth map 712 produced by the TNR block 710 is temporally more stable and reduces temporal inconsistencies.

As previously mentioned, another objective of the present pipeline 700 is to represent different types of objects in the scene using different meshes. Using multiple meshes helps improve depth and edge accuracy, and grouping/categorizing depth measurements based on object allows us to leverage known geometric constraints about those object types to further refine the depth measurements. To this end, a first segmentation 714 may be performed on the image 704 (e.g., brightness image) associated with the current frame N to decompose a visual scene represented by the image 704 into a plurality of layers 716 (e.g., a plurality of segmentation masks) corresponding to different predetermined object types. Each segmentation mask identifies pixels within the image 704 that correspond to one or more objects in the visual scene having a predetermined object type or category. For example, if the visual scene includes one or more body parts (e.g., hands, legs) of the user, background static objects (e.g., table, chair, wall art, painting, etc.), and other people in the scene, then the first segmentation 714 may generate 3 layers/masks, including a first layer/mask corresponding to body parts (e.g., hands, legs) of the self-user, a second layer/mask corresponding to the background static objects, and a third layer/mask corresponding to the other people in the scene.

In particular embodiments, the segmentation 714 discussed herein may be performed using a machine learning (ML) technique. Stated differently, the segmentation may be ML-based segmentation or uses a ML model to perform the segmentation discussed herein. For instance, a ML model may be trained to identify different classes/types of objects in an image and generate image layers/masks corresponding to these different classes/types of objects. The computing system (e.g., the computer 108 or the computer system 1100) may use such a ML model to perform the first segmentation 714 to generate a plurality of segmentation layers/masks 716 corresponding to a plurality of predetermined object types in the visual scene.

In particular embodiments, K depth meshes 718 may be created from the temporally aligned depth map 712 (or optionally, if TNR is not performed, an original depth map output by the depth sensor), using the plurality of segmentation masks 716 (e.g., segmentation layers). Each depth mesh 718 may correspond to one or more objects of a particular type in the visual scene. In particular embodiments, to create a particular mesh 718 corresponding to objects of a particular type (e.g., the user's body), the segmentation layer/mask 716 associated with that object type may be used to extract depth measurements/points from the depth map 712. The extracted portion of the depth map represent depth measurements that likely correspond to the object type of interest. A 3D mesh is then created based on the extracted depth points or point cloud corresponding to the one or more objects of the desired type (e.g., hands). This process may repeat for each segmentation mask 716 to generate a plurality of meshes corresponding to different object types. By way of an example and without limitation, a first mesh may be made only from points corresponding to certain body parts of the user (e.g., hands), a second mesh may be made only from points corresponding to planes, and a third mesh may be made from all other depth points. Stated differently, three meshes may be created in this example, where mesh #1 includes only the user's arms and other observable body parts, mesh #2 includes visible planes in the scene, and mesh #3 includes all other objects in the scene. As another example, if there are K segmentation masks 716 that are generated based on the first segmentation 714 as discussed above, then there may be K depth meshes generated corresponding to these K segmentation masks, where a first depth mesh may correspond to one or more body parts (e.g., hands, legs) of a user wearing the artificial reality device, a second depth mesh may correspond to planes in the visual scene, and a third depth mesh may correspond to background static objects (e.g., table, chair, wall arts, paintings, etc.).

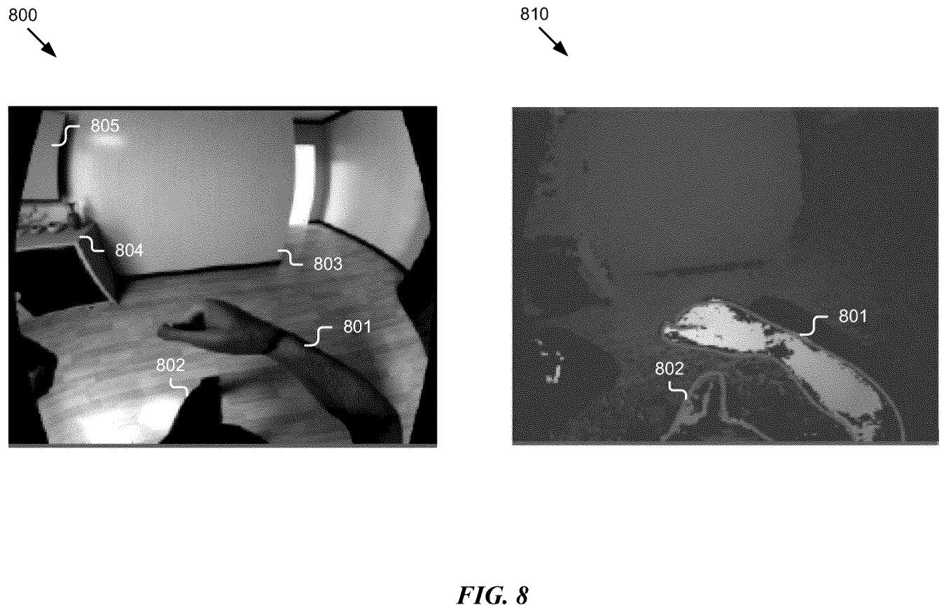

FIG. 8 illustrates an example source image 800 (an example of image 704 shown in FIG. 7) of a visual scene including various objects. A segmentation mask may be generated for the user's body, and another segmentation mask may be generated for the background. The source image 800 may be captured using an external-facing camera (e.g., cameras 105A or 105B) of the artificial reality system 100. As depicted, the image 800 shows user's body parts, such as hand 801 and leg 802, and other objects in the scene, such as wall 803, table 804, and whiteboard 805. Pixels corresponding to the hand 801 and leg 802 may be identified by a first segmentation mask, and pixels corresponding to the background, including the wall 802, table 804, and whiteboard 805 may be identified by a second segmentation mask. The image 810 conceptually illustrates the two segmentation masks applied to a depth map. The first segmentation mask associated with the user's body may be overlaid over the depth map to identify depth measurements/points that correspond to the user's hand 801 and leg 802. Similarly, the second segmentation mask may identify other depth measurements/points that correspond to the background environment.

In particular embodiments, depth measurements extracted from the depth map 712 using the K segmentation masks 716 may be refined/filtered before generating the K meshes 718. Referring back to FIG. 7, the refinement or filtering process is represented by block 720. In some embodiments, depth refinement 720 may include filling missing holes or depth information in a sparse depth map. For instance, a segmented depth map associated with a particular object type may include missing depth information because some portion of the depth map's field of view were occluded or occupied by other types of objects. For instance, foreground object(s) may occlude and/or deform background object(s). Thus, the segmented depth map for the background would have missing depth information previously occupied by depth measurements of the foreground objects. In such scenarios, the computing system discussed herein may fill-in these missing holes or pieces of information using any suitable filtering technique to densify the depth map. In particular embodiments, a Laplacian filter may be used to populate these missing holes or pieces of information. The densified segmented depth map (i.e., all the pixels within the map's field of view have depth values) may then be used to generate a corresponding mesh.

As previously mentioned, one benefit of segmenting the depth measurements based on known object types is that known geometric constraints of those object types may be used to refine the depth measurements. In one embodiment, depth refinement 720 may include refining depth measurements using one or more components 722a, 722b, . . . , 722n (individually and/or collectively referred to as 722) that provide 3D modeling or geometric constraints for depth filtering. These components 722 may be modules or services that detects or tracks certain object types of interest and generate 3D meshes for them. By way of an example and without limitation, the one or more components 722 may include (1) a first component 722a, which may be planes component including information relating to two-dimensional (2D) planes in the visual scene, (2) a second component 722b, which may be people component including information relating to different humans in the scene, and (3) a third component 722n, which may be three-dimensional reconstruction (3DR) component including information relating to observed depth measurements or geometries of static objects in the scene accumulated over a period of time. In particular embodiments, the object types supported by components 722 may correspond to the object types associated with the segmentation masks 716.

Each of the components 722 may include priors (e.g., 3D models or rules) that constrain the geometry of the associated object type. For example, if component 722a is associated with planes, the geometric constraint would be 2D planes as detected by the component 722a. As an example, the computing system may use the planes component (e.g., component 722a) to refine depth measurements within the segmented depth map associated with planes (i.e., the referenced segmented depth map may be generated by extracting depth measurements from the depth map 712 using a segmentation mask 716 associated with planes). In particular embodiments, an optimization algorithm may be used to find an arrangement of planes that would best-fit the observed depth measurements in the segmented depth map associated with planes. Depth measurements in the segmented depth map that don't match the fitted planes may be filtered out. In another embodiment, component 722a may have independently detected planes in the scene and created corresponding meshes to represent them. If so, the refinement 720 may occur at the mesh-level instead of at the depth-map level. For example, after the segmented depth map for planes have been used to create a mesh for planes, portions of the mesh for planes may be replaced by the 3D model of planes independently generated by component 722a.

As another example, the system may use the people component (e.g., component 722b) to refine the depth measurements corresponding to people in the visual scene. In particular embodiments, component 722b may include a human-body model that constrains the possible geometry of the human body. An optimization algorithm may be used to find the pose of one or more human bodies that best fit the observed depth measurements in a segmented depth map associated with people (i.e., the referenced segmented depth map is generated using the segmentation mask associated with people). The 3D fitted model of people may be used to filter out depth measurements in the segmented depth map that are outliers relative to the 3D fitted model of people. After filtering, the resulting segmented depth map may be used to generate a single mesh to represent any number of people in the scene. In other embodiments, depth refinement 720 may include replacing portions of the depth mesh for people generated from a corresponding segmented depth map using the 3D mesh of people generated independently by component 722b.

Once the one or more depth refinements 720 are applied, the resulting refined/filtered K meshes 724 may be saved and kept separate until they are combined at rendering time. At rendering time, a left passthrough image 742a and a right passthrough image 742b may be obtained from sensors of the artificial reality system. For example, left and right passthrough images may be captured by external cameras 105A-105B of the artificial reality system. These captured images 742a and 742b may represent the visual scene or user's physical environment at a current time instance (or second-time instance). However, these captured images 742a and 742b do not include depth. Accurate depth information may need to be obtained for these captured images 742a-b in order to render depth-accurate passthrough images for both eyes from a user's perspective.

In particular embodiments, the captured images 742a and 742b at the current time instance (or second-time instance) associated with passthrough-image generation may be different from the image 704 that was captured by the one or more sensors at a previous time instance (or first-time instance) associated with depth generation. For instance, there may be some time delay between an image 704 captured at the previous time instance and the image (e.g., left passthrough image 742a or right passthrough image 742b) captured at the current time instance and due to this, the objects (e.g., user's hands, other people, etc.) in the visual scene at the current time instance may be relatively at different positions than the objects in the image at the previous time instance. Due to the time delay and/or different positionings of the objects in the visual scene, the refined K meshes 724 may need to be warped and then combined in order to render an output image from a user's current eye perspective. The process for rendering a depth-accurate passthrough image for each eye is discussed in detail below.

To render a depth-accurate passthrough image for each eye, a second segmentation (e.g., ML segmentation) 744a-b may be performed on each of the left passthrough image 742a and the right passthrough image 742b. For instance, the second segmentation 744a may be performed on the left passthrough image 742a to decompose the left passthrough image 742a into a plurality of segmentation masks/layers 746a at the current or second-time instance. Each of these masks 746a may identify pixels in the left passthrough image 742a that correspond to a particular object type of interest, similar to the types identified by the first segmentation process 714. Similarly, the second segmentation 744b may be performed on the right passthrough image 742b to decompose the right passthrough image 742b into a plurality of masks/layers 746b at the current or second-time instance. Each mask of the plurality of masks 746b may correspond to one or more objects of a particular type in the visual scene at the second-time instance. As mentioned earlier, positions of objects in the scene at the second-time instance may be different from the positions of the objects in the previous or first-time instance. This may be due to the time delay between the capture of the segmentation images 742a-b and the brightness image 704. Also, the scene at the second time instance may change due to the user's eye or head position being changed (e.g., the user is now looking at a slightly different angle than before). In addition, the sensors used to capture passthrough images 742a-b may be different from the sensor used to capture brightness image 704. As such, the second segmentation 744a-b process needs to process the passthrough images 742a-b to identify where the objects of interest are within those images 742a-b.

The passthrough images 742a-b will be re-projected to the eye positions of the user. To do so, depth information corresponding to the geometry of the scene is also needed. In particular embodiments, the refined K meshes 724 may need to be warped for each eye. Specifically, in block 730a, the K meshes 724, which were generated based on depth information obtained from the perspective of a depth sensor, are warped so that they represent depth information as observed from the perspective of the left passthrough camera at the second time instance. The warping process would take into account the change in the head pose of the artificial reality device and the extrinsic and intrinsic parameters of the left passthrough camera. The resulting warped meshes 748a would be left eye-specific. Similarly, in block 730b, the K meshes 724 are warped to represent depth information as observed from the perspective of the right passthrough camera at the second time instance. The resulting warped meshes 748b would be right eye-specific. In doing so, the warped meshes 748a-b would provide proper depth information that is aligned with the passthrough images 742a-b, respectively.

Once the meshes are warped for each eye in blocks 730a and 730b, an output image may be rendered for each eye. For instance, in the render block 750a for the left eye, the computing system may composite the K warped meshes 748a for the left eye to generate a single mesh in preparation for rendering. Portions of the K warped meshes 748a may be combined to form a single final mesh according to the segmentation masks 746a associated with the left eye. Similarly, in the render block 750b for the right eye, portions of the K warped meshes 748b may be combined to form another final mesh for the right eye according to the segmentation masks 746b associated with the right eye. In particular embodiments, the rendering in blocks 750a and 750b may include mapping, associating, co-relating, and/or matching each warped mesh 748a-b with their respective segmentation information 746a-b. By way of an example and without limitation, the warped mesh 748a corresponding to body parts of the user is mapped with the segmentation layer/mask 746a associated with body parts of the user. As another example, the warped mesh 748b corresponding to background static objects is mapped with the segmentation layer/mask 746b associated with background static objects. Based on such mappings or correspondences between the warped meshes 730a-b and their respective segmentation layers/masks 746a-b, the computing system could generate composite final meshes for rendering the output images for the left and right eyes. For example, the K segmentation masks 746a for the left eye would be used to extract and combine portions of the corresponding warped meshes 748a to form a final eye-specific mesh for the left eye. This final eye-specific mesh would serve as the geometry information associated with the left passthrough image 742a. The geometry information and the passthrough image 742a may then be used by a rendering engine to render a final output image 752a for the left eye. The viewpoint used for rendering the output image 752a may be a predicted viewpoint of the user's left eye. In a similar manner, the final eye-specific mesh for the right eye and the right passthrough image 742b may be used to render an output image 752b for the right eye. These output images 752a-b may then be respectively output on a left and right eye display of the artificial reality device to give the user a “passthrough” view of the physical environment.

In some embodiments, only meshes corresponding to objects that are currently visible in the left passthrough image 742a and the right passthrough image 742b may be used during the rendering in blocks 750a and 750b. For example, if three meshes were created, where mesh #1 includes only the user's bare hands, mesh #2 includes all other objects in the scene except for the user's bare hands, and mesh #3 includes all objects in the scene, then rendering may be carried out in following rendering modes. In an example first rendering mode, if the user's hands are not visible, then only mesh #3 is used, the same for the left and right eyes. In an example second rendering mode, if the user's hands are visible and there are no objects in the hands and there are no clothes on the hands, then separate meshes are made for the left and right eyes. For this, mesh #1 and mesh #2 may be combined separately for each eye using separate segmentation masks for each eye. In an example third rendering mode, if the user's hands are visible but have objects or clothing, then a combination of first and second rendering modes above may be used. Namely, the areas where the hands have objects or clothes are marked with a fallback behavior mask and rendering takes place in them as in the first rendering mode. And on those parts of the hands that are far from clothes and objects, rendering occurs as in the second rendering mode. The fallback behavior mask may have blurry edges to make the transition between modes smooth. The fallback behavior mask may be stabilized similarly to depth TNR, namely a) the mask may be represented as an image in the range 0-1, b) motion vectors may be used to overlay the fallback behavior mask of this and the previous frame, and c) the previous fallback behavior mask may be averaged with the current one.

In particular embodiments, the output images 752a and 752b that are generated from the render blocks 750a and 750b, respectively, are depth-accurate passthrough images. Each of the output images 752a and 752b may be presented for display on a display component of an artificial reality device, such as the HMD 104 of the artificial reality system 100.

FIG. 9 illustrates an example method 900 for rendering a depth-accurate passthrough image using the improved view synthesis pipeline discussed herein, in accordance with particular embodiments. It should be noted that steps 910-990 of the method 900 correspond to generating a depth-accurate passthrough image for one eye (e.g., left eye) of a user wearing an artificial reality device. Same or similar steps may be repeated for generating a depth-accurate passthrough image for the other eye (e.g., right eye) of the user.

The method 900 may begin at step 910, where a computing system (e.g., the computer 108 or computer system 1100) associated with an artificial reality system (e.g., the artificial reality system 100) may access a depth map and a first image of a scene generated using one or more sensors of an artificial reality device. The artificial reality device may be a mixed reality headset. In some embodiments, the one or more sensors discussed herein are time-of-flight sensors and the first image is an output of the time-of-flight sensor. In some embodiments, the one or more sensors are depth sensors, which are capable of producing depth measurements and brightness images. In other embodiments, the one or more sensors may be a pair of stereo cameras (e.g., cameras 105A-105B) and the first image may be output by one camera of the pair of stereo cameras. When the sensors are stereo cameras, depth measurements may be obtained by comparing the stereo images.

In particular embodiments, an adjusted depth map (e.g., updated/adjusted depth map 712) is generated by temporally smoothing an original depth map output by the one or more sensors, such as, for example, the depth map accessed in step 910 or depth map obtained based on depth measurements 702. Temporally smoothing the original depth map to generate the adjusted depth map may include generating optical flow data to represent motion between the first image and a previous image captured by the one or more sensors, generating a predicted depth map associated with a same time stance as the original depth map by applying the optical flow data to a previous depth map, and generating the adjusted depth map based on the original depth map and the predicted depth map. In particular embodiments, the adjusted depth map (e.g., adjusted depth map 712) is generated by averaging the original depth map and the predicted depth map.

At step 920, the computing system may generate, based on the first image, a plurality of segmentation masks (e.g., segmentation masks 716 at a first time instance) respectively associated with a plurality of object types. Each segmentation mask or layer identifies pixels in the first image that correspond to the object type associated with that segmentation mask. At step 930, the computing system may segment, using the plurality of segmentation masks, the depth map (e.g., adjusted depth map 712) into a plurality of segmented depth maps respectively associated with the plurality of object types.

At step 940, the computing system may generate a plurality of meshes (e.g., K meshes 718) using, respectively, the plurality of segmented depth maps. In particular embodiments, prior to generating the plurality of meshes, the computing system may be further configured to fill missing depth information in at least one of the segmented depth maps using a filter (e.g., Laplacian filter). After the missing information is filled, the plurality of meshes are generated using the plurality of depth maps.

In some embodiments, the plurality of meshes in step 940 are generated using one or more 3D models of the plurality of object types, as discussed in reference to FIG. 7. For example, at least one mesh of the plurality of meshes may be generated by (1) identifying an object type associated with the mesh, the object type being selected from the plurality of object types, (2) generating one or more 3D models of the identified object type that fit observed features of one or more objects of the identified object type present in the scene, and (3) using the one or more 3D models to refine the mesh generated from the associated segmented depth map. The identified object type is at least one of planes, people, or static objects in the scene observed over a period of time.

At steps 950-990, an output image (e.g., depth-accurate passthrough image) may be rendered for each eye of a user wearing the artificial reality device. For instance, at step 950, the computing system, for each eye, may capture a second image of the scene. For example, one of the external cameras 105A-105B may capture the second image (e.g., left passthrough image 742a or right passthrough image 742b) representing the scene surrounding the user at a current or second-time instance. The image representing the visual scene at the second-time instance may be different from the image that was captured by the one or more sensors at a previous or first-time instance. For instance, there may be some time delay between the image captured at the first-time instance and the image captured at the second-time instance and due to this, the objects (e.g., user's hands, other people) in the scene at the second-time instance may be relatively at different positions than the objects in the image at the first-time instance.

At step 960, the computing system may generate, based on the second image, segmentation information identifying pixels in the second image that correspond to the plurality of object types. For example, the computing system may perform a second segmentation on the second image (e.g., brightness image at second-time instance) to decompose the second image into the plurality of segmentation masks/layers (e.g., segmentation masks/layers 746a or 746b) at the second-time instance. In particular embodiments, the second segmentation performed in step 960 is a ML-based segmentation, as discussed elsewhere herein.

At step 970, the computing system may warp the plurality of meshes (e.g., K meshes 724) to generate a plurality of warped meshes (e.g., warped meshes 748a or 748b) for the eye, as discussed in reference to blocks 730a or 730b in FIG. 7. In some embodiments, the plurality of warped meshes for the eye is generated by warping the plurality of meshes based on a location of a camera of the artificial reality device used for capturing the second image. In other embodiments, the plurality of warped meshes for the eye is generated by warping the plurality of meshes based on an updated pose of the artificial reality device.

At step 980, the computing system may generate an eye-specific mesh for the eye (e.g., left eye or right eye) by compositing the plurality of warped meshes for the eye according to the segmentation information of the second image. In some embodiments, generating the eye-specific mesh may include mapping, associating, co-relating, and/or matching each warped mesh corresponding to the one or more objects in the scene with a segmentation mask/layer corresponding to the one or more objects at the second-time instance. More specifically, once a mesh has been warped, it is mapped with a segmentation mask/layer (e.g., obtained after segmenting the second image at the second-time instance) corresponding to that mesh. By way of an example and without limitation, the mesh corresponding to body parts of the user is mapped with the segmentation mask/layer that includes those body parts. As another example, the mesh corresponding to background static objects is mapped with the segmentation mask/layer that includes those background static objects. Once the warped depth meshes are mapped with their corresponding segmentation mask/layers, the mapped warped meshes are combined together to generate the eye-specific mesh.

At step 990, the computing system may render an output image for the eye (e.g., output image 752a for the left eye or output image 752b for the right eye) using the second image and the eye-specific mesh. In some embodiments, the rendering discussed herein may be performed according to the passthrough rendering process discussed in reference to FIG. 4. In particular embodiments, the plurality of warped meshes, the eye-specific mesh, and the output image generated for a left eye of the user are different from the plurality of warped meshes, the eye-specific mesh, and the output image generated for a right eye of the user.

Once the output image is rendered, the computing system may present the output image for display on a display component of the artificial reality device, such as the HMD 104 of the artificial reality system 100. In particular embodiments, the output image is a depth-accurate passthrough image that is generated for one eye of a user wearing the artificial reality device. For example, the output image is either the output image 752a for the left eye or the output image 752b for the right eye. Similarly, the method 900 may render an output image for the other eye using the steps 950-990 discussed herein. Once the images for both eyes are rendered and displayed, the method 900 ends.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for rendering a depth-accurate passthrough image using the improved view synthesis pipeline, including the particular steps of the method of FIG. 9, this disclosure contemplates any suitable method for rendering a depth-accurate passthrough image using the improved view synthesis pipeline, including any suitable steps, which may include a subset of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

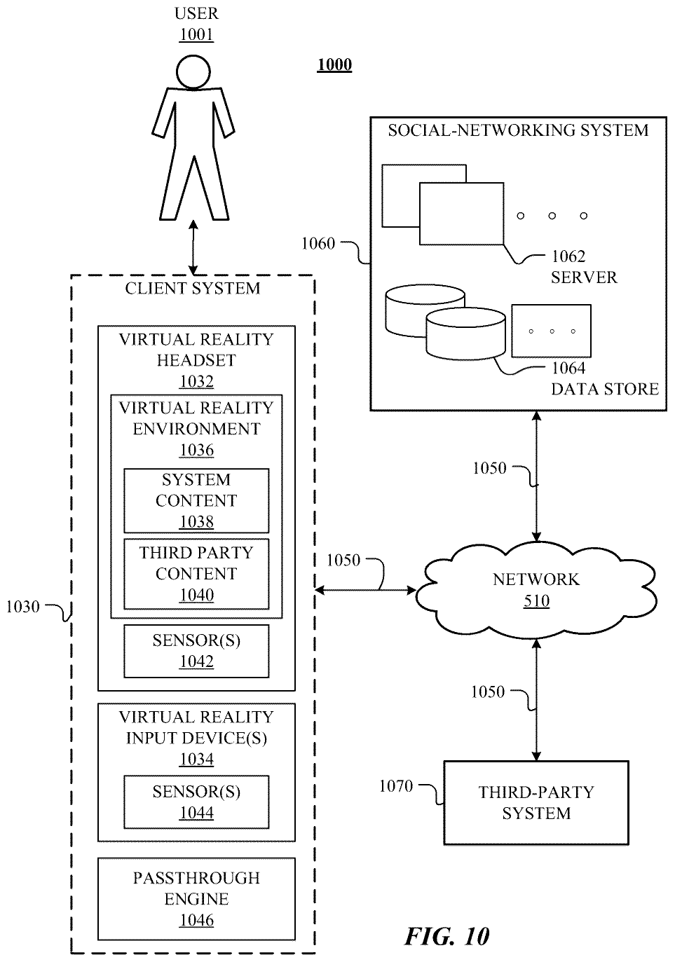

FIG. 10 illustrates an example network environment 1000 associated with an artificial reality system. Although FIG. 10 may be illustrated with a virtual reality system, this example network environment 1000 may include one or more other artificial reality systems, such as mixed reality systems, augmented reality systems, etc. Network environment 1000 includes a user 1001 interacting with a client system 1030, a social-networking system 1060, and a third-party system 1070 connected to each other by a network 1010. Although FIG. 10 illustrates a particular arrangement of a user 1001, a client system 1030, a social-networking system 1060, a third-party system 1070, and a network 1010, this disclosure contemplates any suitable arrangement of a user 1001, a client system 1030, a social-networking system 1060, a third-party system 1070, and a network 1010. As an example and not by way of limitation, two or more of a user 1001, a client system 1030, a social-networking system 1060, and a third-party system 1070 may be connected to each other directly, bypassing a network 1010. As another example, two or more of a client system 1030, a social-networking system 1060, and a third-party system 1070 may be physically or logically co-located with each other in whole or in part. Moreover, although FIG. 10 illustrates a particular number of users 1001, client systems 1030, social-networking systems 1060, third-party systems 1070, and networks 1010, this disclosure contemplates any suitable number of client systems 1030, social-networking systems 1060, third-party systems 1070, and networks 1010. As an example and not by way of limitation, network environment 1000 may include multiple users 1001, client systems 1030, social-networking systems 1060, third-party systems 1070, and networks 1010.

This disclosure contemplates any suitable network 1010. As an example and not by way of limitation, one or more portions of a network 1010 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 1010 may include one or more networks 1010.

Links 1050 may connect a client system 1030, a social-networking system 1060, and a third-party system 1070 to a communication network 1010 or to each other. This disclosure contemplates any suitable links 1050. In particular embodiments, one or more links 1050 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1050 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1050, or a combination of two or more such links 1050. Links 1050 need not necessarily be the same throughout a network environment 1000. One or more first links 1050 may differ in one or more respects from one or more second links 1050.

In particular embodiments, a client system 1030 may be an electronic device including hardware, software, or embedded logic components or a combination of two or more such components and capable of carrying out the appropriate functionalities implemented or supported by a client system 1030. As an example and not by way of limitation, a client system 1030 may include a computer system such as a desktop computer, notebook or laptop computer, netbook, a tablet computer, e-book reader, GPS device, camera, personal digital assistant (PDA), handheld electronic device, cellular telephone, smartphone, virtual reality or mixed reality headset and controllers, other suitable electronic device, or any suitable combination thereof. This disclosure contemplates any suitable client systems 1030. A client system 1030 may enable a network user at a client system 1030 to access a network 1010. A client system 1030 may enable its user to communicate with other users at other client systems 1030. A client system 1030 may generate a virtual reality environment or a mixed reality environment for a user to interact with content.

In particular embodiments, a client system 1030 may include a virtual reality (or augmented reality or mixed reality) headset 1032, and virtual reality input device(s) 1034, such as a virtual reality controller. A user at a client system 1030 may wear the virtual reality headset 1032 and use the virtual reality input device(s) to interact with a virtual reality environment 1036 generated by the virtual reality headset 1032. Although not shown, a client system 1030 may also include a separate processing computer and/or any other component of a virtual reality system. A virtual reality headset 1032 may generate a virtual reality environment 1036, which may include system content 1038 (including but not limited to the operating system), such as software or firmware updates and also include third-party content 1040, such as content from applications or dynamically downloaded from the Internet (e.g., web page content). A virtual reality headset 1032 may include sensor(s) 1042, such as accelerometers, gyroscopes, magnetometers to generate sensor data that tracks the location of the headset device 1032. The headset 1032 may also include eye trackers for tracking the position of the user's eyes or their viewing directions. The client system 1030 may use data from the sensor(s) 1042 to determine velocity, orientation, and gravitation forces with respect to the headset. Virtual reality input device(s) 1034 may include sensor(s) 1044, such as accelerometers, gyroscopes, magnetometers, and touch sensors to generate sensor data that tracks the location of the input device 1034 and the positions of the user's fingers. The client system 1030 may make use of outside-in tracking, in which a tracking camera (not shown) is placed external to the virtual reality headset 1032 and within the line of sight of the virtual reality headset 1032. In outside-in tracking, the tracking camera may track the location of the virtual reality headset 1032 (e.g., by tracking one or more infrared LED markers on the virtual reality headset 1032). Alternatively or additionally, the client system 1030 may make use of inside-out tracking, in which a tracking camera (not shown) may be placed on or within the virtual reality headset 1032 itself. In inside-out tracking, the tracking camera may capture images around it in the real world and may use the changing perspectives of the real world to determine its own position in space.

In particular embodiments, client system 1030 (e.g., an HMD) may include a passthrough engine 1046 to provide the passthrough feature described herein, and may have one or more add-ons, plug-ins, or other extensions. A user at client system 1030 may connect to a particular server (such as server 1062, or a server associated with a third-party system 1070). The server may accept the request and communicate with the client system 1030.

Third-party content 1040 may include a web browser and may have one or more add-ons, plug-ins, or other extensions. A user at a client system 1030 may enter a Uniform Resource Locator (URL) or other address directing a web browser to a particular server (such as server 1062, or a server associated with a third-party system 1070), and the web browser may generate a Hyper Text Transfer Protocol (HTTP) request and communicate the HTTP request to server. The server may accept the HTTP request and communicate to a client system 1030 one or more Hyper Text Markup Language (HTML) files responsive to the HTTP request. The client system 1030 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation combinations of markup language and scripts, and the like. Herein, reference to a web interface encompasses one or more corresponding source files (which a browser may use to render the web interface) and vice versa, where appropriate.

In particular embodiments, the social-networking system 1060 may be a network-addressable computing system that can host an online social network. The social-networking system 1060 may generate, store, receive, and send social-networking data, such as, for example, user-profile data, concept-profile data, social-graph information, or other suitable data related to the online social network. The social-networking system 1060 may be accessed by the other components of network environment 1000 either directly or via a network 1010. As an example and not by way of limitation, a client system 1030 may access the social-networking system 1060 using a web browser of a third-party content 1040, or a native application associated with the social-networking system 1060 (e.g., a mobile social-networking application, a messaging application, another suitable application, or any combination thereof) either directly or via a network 1010. In particular embodiments, the social-networking system 1060 may include one or more servers 1062. Each server 1062 may be a unitary server or a distributed server spanning multiple computers or multiple datacenters. Servers 1062 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 1062 may include hardware, software, or embedded logic components or a combination of two or more such components for carrying out the appropriate functionalities implemented or supported by server 1062. In particular embodiments, the social-networking system 1060 may include one or more data stores 1064. Data stores 1064 may be used to store various types of information. In particular embodiments, the information stored in data stores 1064 may be organized according to specific data structures. In particular embodiments, each data store 1064 may be a relational, columnar, correlation, or other suitable database. Although this disclosure describes or illustrates particular types of databases, this disclosure contemplates any suitable types of databases. Particular embodiments may provide interfaces that enable a client system 1030, a social-networking system 1060, or a third-party system 1070 to manage, retrieve, modify, add, or delete, the information stored in data store 1064.

In particular embodiments, the social-networking system 1060 may store one or more social graphs in one or more data stores 1064. In particular embodiments, a social graph may include multiple nodes—which may include multiple user nodes (each corresponding to a particular user) or multiple concept nodes (each corresponding to a particular concept)—and multiple edges connecting the nodes. The social-networking system 1060 may provide users of the online social network the ability to communicate and interact with other users. In particular embodiments, users may join the online social network via the social-networking system 1060 and then add connections (e.g., relationships) to a number of other users of the social-networking system 1060 whom they want to be connected to. Herein, the term “friend” may refer to any other user of the social-networking system 1060 with whom a user has formed a connection, association, or relationship via the social-networking system 1060.

In particular embodiments, the social-networking system 1060 may provide users with the ability to take actions on various types of items or objects, supported by the social-networking system 1060. As an example and not by way of limitation, the items and objects may include groups or social networks to which users of the social-networking system 1060 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 1060 or by an external system of a third-party system 1070, which is separate from the social-networking system 1060 and coupled to the social-networking system 1060 via a network 1010.

In particular embodiments, the social-networking system 1060 may be capable of linking a variety of entities. As an example and not by way of limitation, the social-networking system 1060 may enable users to interact with each other as well as receive content from third-party systems 1070 or other entities, or to allow users to interact with these entities through an application programming interfaces (API) or other communication channels.

In particular embodiments, a third-party system 1070 may include one or more types of servers, one or more data stores, one or more interfaces, including but not limited to APIs, one or more web services, one or more content sources, one or more networks, or any other suitable components, e.g., that servers may communicate with. A third-party system 1070 may be operated by a different entity from an entity operating the social-networking system 1060. In particular embodiments, however, the social-networking system 1060 and third-party systems 1070 may operate in conjunction with each other to provide social-networking services to users of the social-networking system 1060 or third-party systems 1070. In this sense, the social-networking system 1060 may provide a platform, or backbone, which other systems, such as third-party systems 1070, may use to provide social-networking services and functionality to users across the Internet.

In particular embodiments, a third-party system 1070 may include a third-party content object provider. A third-party content object provider may include one or more sources of content objects, which may be communicated to a client system 1030. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 1060 also includes user-generated content objects, which may enhance a user's interactions with the social-networking system 1060. User-generated content may include anything a user can add, upload, send, or “post” to the social-networking system 1060. As an example and not by way of limitation, a user communicates posts to the social-networking system 1060 from a client system 1030. Posts may include data such as status updates or other textual data, location information, photos, videos, links, music or other similar data or media. Content may also be added to the social-networking system 1060 by a third-party through a “communication channel,” such as a newsfeed or stream.

In particular embodiments, the social-networking system 1060 may include a variety of servers, sub-systems, programs, modules, logs, and data stores. In particular embodiments, the social-networking system 1060 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 1060 may also include suitable components such as network interfaces, security mechanisms, load balancers, failover servers, management-and-network-operations consoles, other suitable components, or any suitable combination thereof. In particular embodiments, the social-networking system 1060 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 1060 to one or more client systems 1030 or one or more third-party systems 1070 via a network 1010. The web server may include a mail server or other messaging functionality for receiving and routing messages between the social-networking system 1060 and one or more client systems 1030. An API-request server may allow a third-party system 1070 to access information from the social-networking system 1060 by calling one or more APIs. An action logger may be used to receive communications from a web server about a user's actions on or off the social-networking system 1060. In conjunction with the action log, a third-party-content-object log may be maintained of user exposures to third-party-content objects. A notification controller may provide information regarding content objects to a client system 1030. Information may be pushed to a client system 1030 as notifications, or information may be pulled from a client system 1030 responsive to a request received from a client system 1030. Authorization servers may be used to enforce one or more privacy settings of the users of the social-networking system 1060. A privacy setting of a user determines how particular information associated with a user can be shared. The authorization server may allow users to opt in to or opt out of having their actions logged by the social-networking system 1060 or shared with other systems (e.g., a third-party system 1070), such as, for example, by setting appropriate privacy settings. Third-party-content-object stores may be used to store content objects received from third parties, such as a third-party system 1070. Location stores may be used for storing location information received from client systems 1030 associated with users. Advertisement-pricing modules may combine social information, the current time, location information, or other suitable information to provide relevant advertisements, in the form of notifications, to a user.

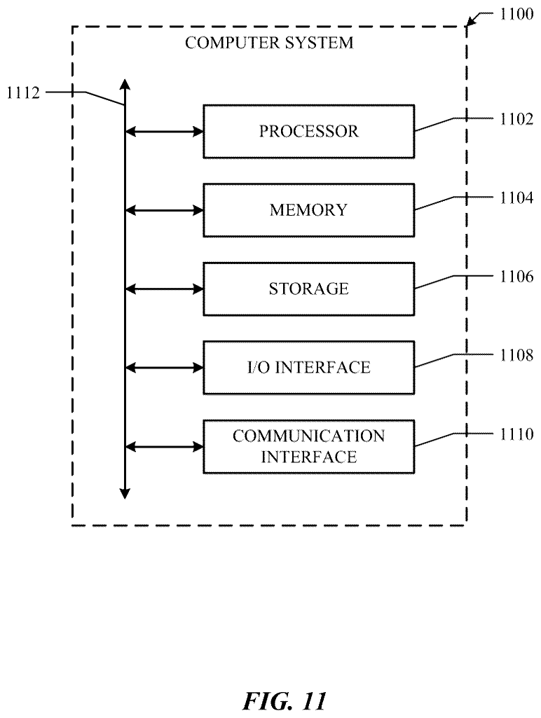

FIG. 11 illustrates an example computer system 1100. In particular embodiments, one or more computer systems 1100 perform one or more steps of one or more processes, algorithms, techniques, or methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing a depth map and a first image of a scene generated using one or more sensors of an artificial reality device;
generating, based on the first image, a plurality of segmentation masks respectively associated with a plurality of object types, wherein each segmentation mask identifies pixels in the first image that correspond to the object type associated with that segmentation mask;
segmenting, using the plurality of segmentation masks, the depth map into a plurality of segmented depth maps respectively associated with the plurality of object types;
generating a plurality of meshes using, respectively, the plurality of segmented depth maps;
for each eye of a user:
capturing a second image of the scene;
generating, based on the second image, segmentation information identifying pixels in the second image that correspond to the plurality of object types;
warping the plurality of meshes to generate a plurality of warped meshes for the eye;
generating an eye-specific mesh for the eye by compositing the plurality of warped meshes for the eye according to the segmentation information of the second image; and
rendering an output image for the eye using the second image and the eye-specific mesh.

2. The method of claim 1, wherein the depth map is generated by temporally smoothing an original depth map output by the one or more sensors.

3. The method of claim 2, wherein temporally smoothing the original depth map to generate the depth map comprises:
generating optical flow data to represent motion between the first image and a previous image captured by the one or more sensors;
generating a predicted depth map associated with a same time stance as the original depth map by applying the optical flow data to a previous depth map; and
generating the depth map based on the original depth map and the predicted depth map.

4. The method of claim 3, wherein the depth map is generated by averaging the original depth map and the predicted depth map.

5. The method of claim 1, wherein the one or more sensors comprise a time-of-flight sensor, and the first image is an output of the time-of-flight sensor.

6. The method of claim 1, wherein the one or more sensors comprise a pair of stereo cameras, and the first image is output by one camera of the pair of stereo cameras.

7. The method of claim 1, further comprising:
before generating the plurality of meshes, filling missing depth information in at least one of the segmented depth maps using a filter, wherein the plurality of meshes are generated using the plurality of depth maps after the missing information is filled.

8. The method of claim 1, wherein generating the plurality of meshes further comprises using one or more 3D models of the plurality of object types.

9. The method of claim 8, wherein at least one mesh of the plurality of meshes is generated by:
identifying an object type associated with the mesh, the object type being selected from the plurality of object types;
generating one or more 3D models of the identified object type that fit observed features of one or more objects of the identified object type present in the scene; and
using the one or more 3D models to refine the mesh generated from the associated segmented depth map.

10. The method of claim 9, wherein the identified object type is at least one of planes, people, or static objects in the scene observed over a period of time.

11. The method of claim 1, wherein the plurality of warped meshes, the eye-specific mesh, and the output image generated for a left eye of the user are different from the plurality of warped meshes, the eye-specific mesh, and the output image generated for a right eye of the user.

12. The method of claim 1, wherein the plurality of warped meshes for the eye is generated by warping the plurality of meshes based on a location of a camera of the artificial reality device used for capturing the second image.

13. The method of claim 11, wherein the plurality of warped meshes for the eye is generated by warping the plurality of meshes based on an updated pose of the artificial reality device.

14. One or more computer-readable non-transitory storage media embodying software that is operable when executed to:
access a depth map and a first image of a scene generated using one or more sensors of an artificial reality device;
generate, based on the first image, a plurality of segmentation masks respectively associated with a plurality of object types, wherein each segmentation mask identifies pixels in the first image that correspond to the object type associated with that segmentation mask;
segment, using the plurality of segmentation masks, the depth map into a plurality of segmented depth maps respectively associated with the plurality of object types;
generate a plurality of meshes using, respectively, the plurality of segmented depth maps;
for each eye of a user:
capture a second image of the scene;
generate, based on the second image, segmentation information identifying pixels in the second image that correspond to the plurality of object types;
warp the plurality of meshes to generate a plurality of warped meshes for the eye;
generate an eye-specific mesh for the eye by compositing the plurality of warped meshes for the eye according to the segmentation information of the second image; and
render an output image for the eye using the second image and the eye-specific mesh.

15. The one or more computer-readable non-transitory storage media of claim 14, wherein the depth map is generated by temporally smoothing an original depth map output by the one or more sensors.

16. The one or more computer-readable non-transitory storage media of claim 15, wherein temporally smoothing the original depth map to generate the depth map comprises:
generate optical flow data to represent motion between the first image and a previous image captured by the one or more sensors;
generate a predicted depth map associated with a same time stance as the original depth map by applying the optical flow data to a previous depth map; and
generate the depth map based on the original depth map and the predicted depth map.

17. The one or more computer-readable non-transitory storage media of claim 14, wherein generation of the plurality of meshes further comprises using one or more 3D models of the plurality of object types.

18. An artificial reality device comprising:
one or more sensors;
at least one display component;
one or more processors; and
one or more computer-readable non-transitory storage media coupled to one or more of the processors and comprising instructions operable when executed by one or more of the processors to cause the artificial reality device to:
access a depth map and a first image of a scene generated using one or more sensors of an artificial reality device;
generate, based on the first image, a plurality of segmentation masks respectively associated with a plurality of object types, wherein each segmentation mask identifies pixels in the first image that correspond to the object type associated with that segmentation mask;
segment, using the plurality of segmentation masks, the depth map into a plurality of segmented depth maps respectively associated with the plurality of object types;
generate a plurality of meshes using, respectively, the plurality of segmented depth maps;
for each eye of a user:
capture a second image of the scene;
generate, based on the second image, segmentation information identifying pixels in the second image that correspond to the plurality of object types;
warp the plurality of meshes to generate a plurality of warped meshes for the eye;
generate an eye-specific mesh for the eye by compositing the plurality of warped meshes for the eye according to the segmentation information of the second image; and
render an output image for the eye using the second image and the eye-specific mesh.

19. The artificial reality device of claim 18, wherein the depth map is generated by temporally smoothing an original depth map output by the one or more sensors.

20. The artificial reality device of claim 19, wherein temporally smoothing the original depth map to generate the depth map comprises:
generate optical flow data to represent motion between the first image and a previous image captured by the one or more sensors;
generate a predicted depth map associated with a same time stance as the original depth map by applying the optical flow data to a previous depth map; and
generate the depth map based on the original depth map and the predicted depth map.
